(19) United States
(12) Patent Application Publication
(10) Pub. No.: US 2014/0337755 A1
(43) Pub. Date: Nov. 13, 2014

(54) EXCHANGING CONTENT AND TOOLS BETWEEN USERS

(71) Applicant: Nigel Pearce, Blackburn Lancashire (GB)

(72) Inventor: Nigel Pearce, Blackburn Lancashire (GB)

(73) Assignee: PROMETHEAN LIMITED, Blackburn Lancashire (GB)

(21) Appl. No.: 14/129,746

(22) PCT Filed: Jun. 27, 2012
(86) PCT No.: PCT/EP2012/062432

§ 371 Date: Jul. 31, 2014

(30) Foreign Application Priority Data
Jun. 27, 2011 (GB) 1110846.1

(51) Int. Cl. G06F 3/0484; G06F 3/0488; G06F 3/0481

(52) U.S. Cl. CPC G06F 3/0484; G06F 3/04817; G06F 3/04886
USPC 715/750

(57) ABSTRACT

There is disclosed a method for an interactive display surface adapted to detect multiple inputs, the method comprising: associating a plurality of displayed objects with a respective plurality of inputs; and selectively exchanging the objects between at least two inputs.

### BACKGROUND TO THE INVENTION

1. Field of the Invention

The present invention relates to interactive display surfaces arranged to detect multiple inputs, which in use may be presented in a horizontal or vertical arrangement. The invention is particularly but not exclusively concerned with such surfaces being provided with touch inputs from a plurality of different sources.

2. Description of the Related Art

Interactive surfaces which are adapted to detect touch inputs are well-known in the art. Such an interactive surface may be arranged to have a display to display graphical information and/or images to a user. A user is able to touch the surface at a position at which an object is displayed in order to select the object, or move the touch contact across the surface in order to move the object. Similarly a touch contact may be used to draw or annotate on the display of the touch surface.

Various applications for such touch sensitive surfaces are well-known in the art, such as in handheld electronic devices such as mobile phones or personal data assistants (PDAs). On a larger scale, such touch surfaces are also known as part of interactive display systems, such as electronic whiteboards. More recently, touch sensitive display surfaces have been shown as being used for interactive tables, where the display surface is disposed in a horizontal plane as a table surface.

It is also known in the art of touch sensitive display surfaces to include such surfaces in a collaborative input system, to allow for multiple users to interact with the touch sensitive display simultaneously. In practice multiple inputs can be received from a single user, as well as from a plurality of users. The interactive touch sensitive surface is adapted to be responsive to touch inputs in general, and thus is responsive to a plurality of touch inputs.

With an interactive display surface arranged as a table adapted for collaborative working, the ability to detect multiple inputs allows multiple users to be positioned around the interactive display surface and work simultaneously. Each user may work in their own defined area or with their own defined application, but also users may work collaboratively, swapping information between them.

It is an aim of the present invention to provide an improved user interface for a collaborative input system comprising an interactive display surface for detecting multiple inputs, to facilitate collaborative working.

### SUMMARY OF THE INVENTION

In one aspect the invention provides a method for an interactive display surface adapted to detect multiple inputs, the method comprising: associating a plurality of displayed objects with a respective plurality of inputs; and selectively exchanging the objects between at least two inputs.

The objects may comprise user content. The plurality of displayed objects may comprise a plurality of displayed tools. The plurality of displayed objects may comprise a plurality of displayed content of a document under the control of a tool. The plurality of displayed objects may comprise a displayed tool and a displayed content associated with said tool. The plurality of inputs may be associated with a respective plurality of users.

The method may further comprise displaying a graphical user icon in association with at least one of said objects, wherein the step of selectively exchanging is initiated responsive to selection of said icon. Responsive to selection of said icon, a further graphical user icon may be displayed in association with at least one further object, wherein responsive to selection of said further icon the step of exchanging is enabled. The step of exchanging may be enabled between the input associated with the icon and the input associated with the further icon which is first selected. The step of exchanging may be enabled between the input associated with the icon and all inputs associated with further icons which are selected. The exchange may be based on an exchange between inputs in dependence on an order of inputs. Each object may be exchanged with the input next adjacent in the order.

The step of exchanging may comprise exchanging the content associated with objects.

The step of exchanging may comprise exchanging the tool associated with objects.

The step of exchanging may comprise exchanging the content and tool associated with objects.

The plurality of inputs may be associated with a common application, the objects associated with each input being displayed under control of the common application. The common application is a collaborative task.

Each of the plurality of inputs may be associated with one of a respective plurality of users, the plurality of displayed objects comprising a plurality of tools associated with each of the plurality of users and a common displayed content, and each tool being associated with an editing capability of the common displayed content, the step of selectively exchanging the objects between at least two inputs comprising selectively exchanging the tools between at least two users.

Each of the plurality of inputs may be associated with one of a respective plurality of users, the plurality of displayed objects comprising a respective plurality of content for editing by each user with a respective plurality of tools having a common function, the step of selectively exchanging the objects between at least two inputs comprising selectively exchanging the content for editing between at least two users. The icon may be displayed adjacent, in combination with, or coincident with the displayed object.

In another aspect the invention provides a computer system for an interactive display surface adapted to detect multiple inputs, further adapted to: associate a plurality of displayed objects with a respective plurality of inputs; and selectively exchange the objects between at least two inputs.

The objects may comprise user content. The plurality of displayed objects may comprise a plurality of displayed tools. The plurality of displayed objects may comprise a plurality of displayed content of a document under the control of a tool. The plurality of displayed objects may comprise a displayed tool and a displayed content associated with said tool. The plurality of inputs may be associated with a respective plurality of users.

The computer system may further be adapted to display a graphical user icon in association with at least one of said objects, wherein selectively exchanging is initiated responsive to selection of said icon.

Responsive to selection of said icon, a further graphical user icon may be displayed in association with at least one further object, wherein responsive to selection of said further icon the step of exchanging is enabled. The exchanging may be adapted to be enabled between the input associated with the icon and the input associated with the further icon which is first selected. The exchanging may be adapted to be enabled between the input associated with the icon and all inputs associated with further icons which are selected. The exchange may be based on an exchange between inputs in dependence on an order of inputs. Each object may be exchanged with the input next adjacent in the order. The exchanging may comprise exchanging the content associated with objects.

The exchanging may be adapted to comprise exchanging the tool associated with objects.

The exchanging may be adapted to comprise exchanging the content and tool associated with objects.

The plurality of inputs may be associated with a common application, the objects associated with each input being displayed under control of the common application.

The common application may be a collaborative task.

Each of the plurality of inputs may be associated with one of a respective plurality of users, the plurality of displayed objects comprising a plurality of tools associated with each of the plurality of users and a common displayed content, and each tool being associated with an editing capability of the common displayed content, the selectively exchanging the objects between at least two inputs comprising selectively exchanging the tools between at least two users.

Each of the plurality of inputs may be associated with one of a respective plurality of users, the plurality of displayed objects comprising a respective plurality of content for editing by each user with a respective plurality of tools having a common function, the step of selectively exchanging the objects between at least two inputs comprising selectively exchanging the content for editing between at least two users.

The icon may be displayed adjacent, in combination with, or coincident with the displayed object.

### BRIEF DESCRIPTION OF THE DRAWINGS

The invention will now be described by way of reference to the accompanying Figures in which:

FIG. 1 illustrates an implementation scenario in which the embodiments of the invention may be implemented;

FIGS. 2(a) to 2(d) illustrate an embodiment in accordance with an embodiment of the invention;

FIG. 3 illustrates a flow process corresponding to the embodiment of FIGS. 2(a) to 2(d);

FIGS. 4(a) to 4(d) illustrate an embodiment in accordance with an embodiment of the invention;

FIG. 5 illustrates a flow process corresponding to the embodiment of FIGS. 4(a) to 4(d); and

FIG. 6 illustrates functional elements for implementing the methods in accordance with embodiments of the invention.

### DESCRIPTION OF THE PREFERRED EMBODIMENTS

The invention is now described by way of reference to various examples, embodiments, and advantageous applications. One skilled in the art will appreciate that the invention is not limited to the details of any described example, embodiment or detail. In particular the invention may be described with reference to exemplary interactive display systems. One skilled in the art will appreciate that the principles of the invention are not limited to any such described systems.

The invention is described herein with reference to a touch sensitive interactive display surface for collaborative working. The invention is particularly described in the context of such a surface provided as a horizontal—or ‘table-top’—surface, but is not limited to such a specific user arrangement.

The invention is not limited to any particular type of touch sensitive technology, nor to any particular type of display technology. In examples, the display of the touch sensitive surface may be provided by a projector projecting images onto the touch sensitive surface. In other examples the display may be provided by the touch sensitive surface being an emissive surface. Various other options exist as will be understood by one skilled in the art. In general the surface is described herein as a touch sensitive surface, which may have images projected thereon (e.g. by a projector) or which may also be an emissive display surface.

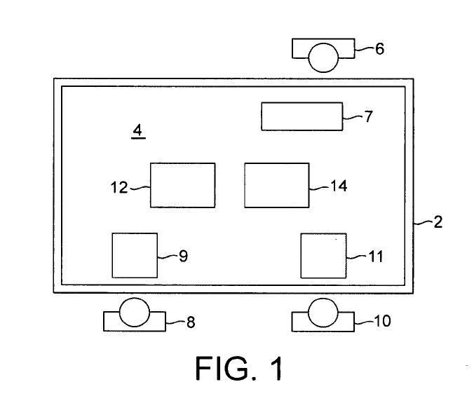

FIG. 1 shows an arrangement for collaborative working at a horizontal interactive display surface, providing an exemplary implementation scenario for embodiments of the present invention.

Multiple users 6, 8, 10 are positioned around a horizontal interactive display surface 4 of a table-top type structure 2. Each user 6, 8, 10 has in front of them a working area. The working area may be defined by a physical portion of the interactive display surface, or by the display of an application on the interactive display surface for that user.

In FIG. 1, each of the users is illustrated as having an associated window with which they are currently working. User 6 is associated with a window 7 displayed on the interactive display surface 4 at a position in front of the user 6. User 8 is associated with a window 9 displayed on the interactive display surface 4 at a position in front of the user 8. User 10 is associated with a window 11 displayed on the interactive display surface 4 at a position in front of the user 10. Reference to a window here means a portion of the interactive display surface 4 on which an application or content is displayed.

Some users may have multiple windows, associated with different applications or different windows within a single application. For example in FIG. 1 additional windows 112 and 114 are illustrated, which may be associated with either of the users 8 and 10. Windows may also comprise tools and general content, rather than just applications.

In collaborative tasks, for example, users may preferably share or exchange content and/or tools. This permits for truly collaborative working.

For example, with reference to FIG. 1, the user 6 may wish to move the window 7 to user 8 or 10. With interactive display surfaces, this may be typically be done a by user 6 ‘throwing’ the window across the surface (e.g. by applying a sliding motion to the displayed window in the direction of the other user).

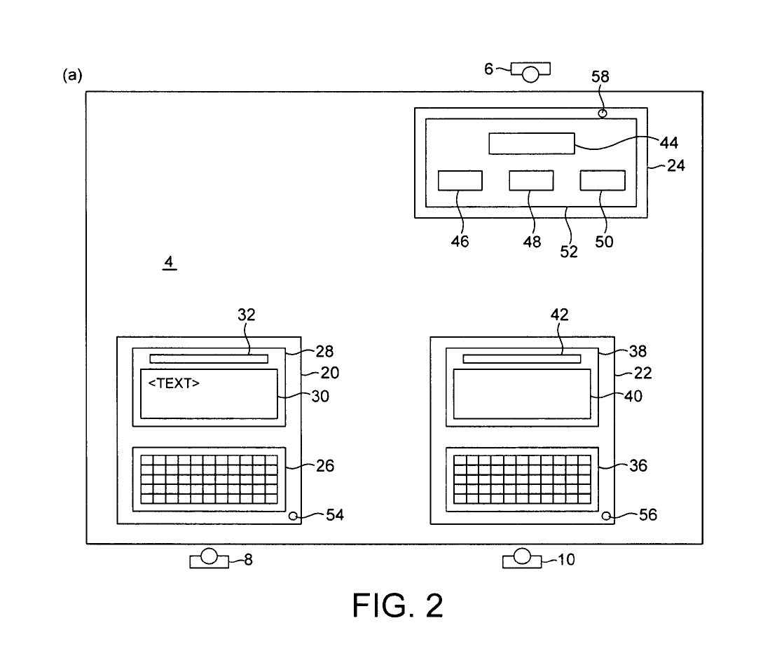

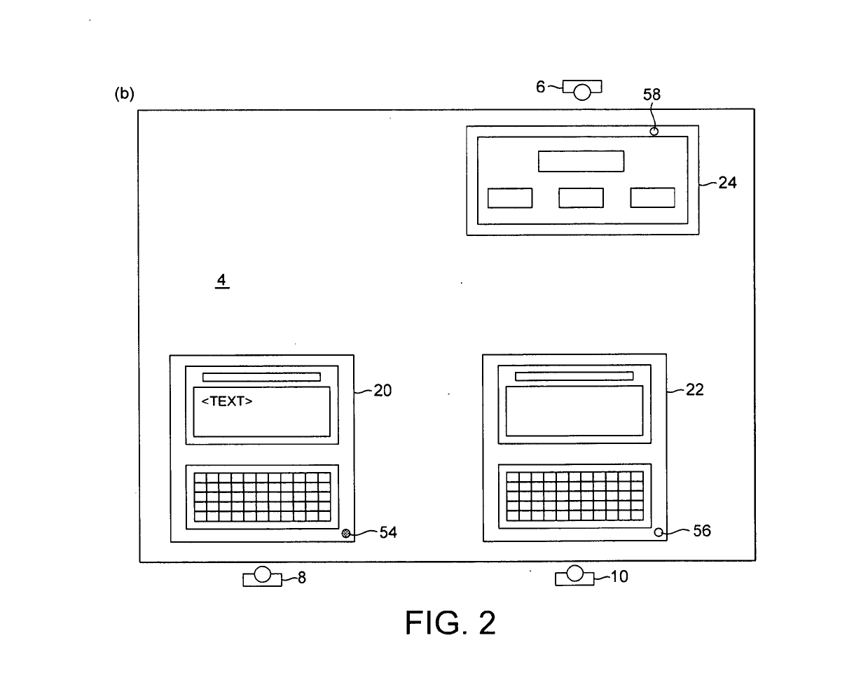

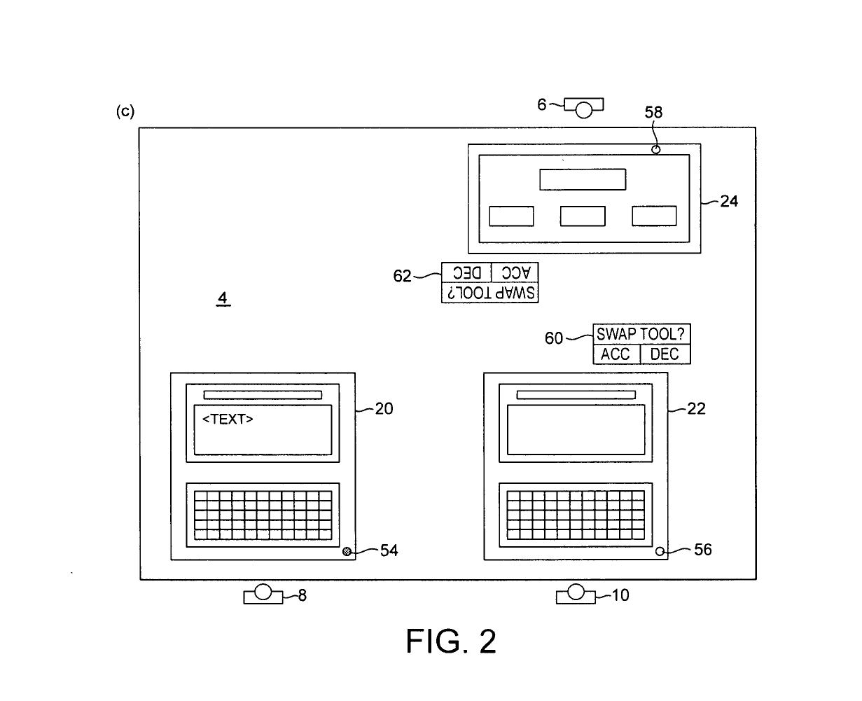

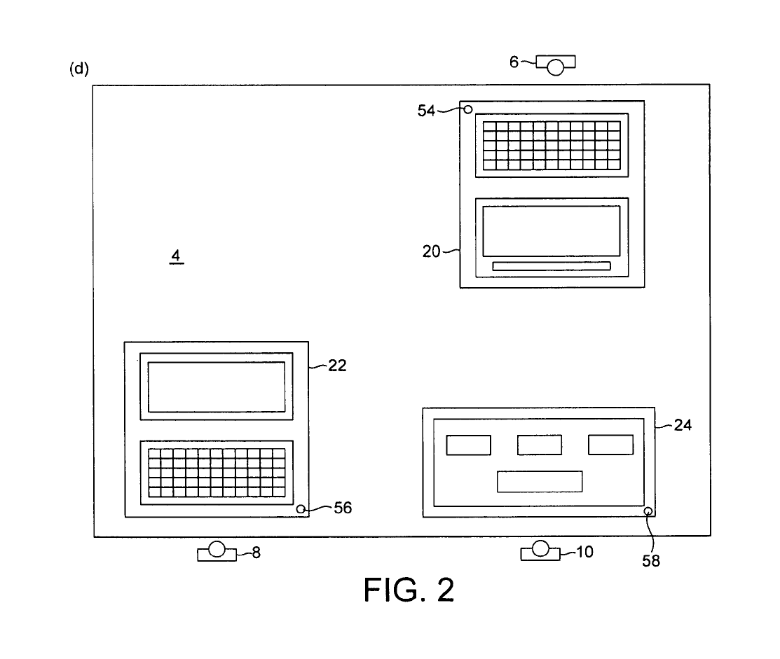

A first embodiment of the invention is now described with reference to FIGS. 2(a) to 2(d).

There is illustrated three work areas 20, 22, 24 on an interactive display surface 4. Each work area may comprise multiple sub areas, including tools and content and user input areas. The work area 20 is associated with user 8; the work area 22 is associated with user 10; and the work area 24 is associated with user 6.

The work area 20 includes a virtual keyboard 26, a display area 28 including a display 30 for displaying text entered via the keyboard, and a ribbon display area 32, for example for entering a URL to enter a website. The work area 22 includes a virtual keyboard 36, a display area 38 including a display 40 for displaying text entered via the keyboard, and a ribbon display area 42. The work area 24 comprises a plurality of display areas 44, 46, 48, 50 within a general display area 52. One skilled in the art will fully appreciate the variety of displays and input areas that may be provided in the work areas 10, 22, 24, and will also understand that the work areas may be defined by a physical portion of the display surface, or simply by the extent of the displayed area.

As further illustrated in FIG. 2(a) each work area 20, 22, 24 has displayed therewith an additional user interface icon, which may be displayed as a button. This may be displayed on the periphery of the work area. As illustrated in FIG. 2, an additional user interface icon 54 is associated with work area 20; an additional user interface icon 56 is associated with work area 22; and an additional user interface icon 58 is associated with work area 24.

The additional user interface icons 54, 56, 58—which will be referred to hereafter as buttons—are provided to enable collaborative sharing between the users. The buttons may be referred to as collaborative sharing buttons. The buttons are used by the users to initiate or request an exchange of tools and/or content and/or to accept a request for an exchange of tools and/or content.

As illustrated in FIG. 2(b), the button 54 associated with the work area 20 is shown as shaded, indicating that it has been selected by the user 8. The manner in which the selection of the button is displayed will be implementation dependent, but as is usual with a user interface the appearance of the button may change in some way to indicate that it has been selected. The user has thus selected to make a request for content to be exchanged between collaborative users.

As illustrated in FIG. 2(c), responsive to selection of the button 54 by the user 8 each of the other two users 6, 10 have a window displayed adjacent their work area, responsive to the selection of the button in FIG. 2(b), requesting them to swap a tool.

As illustrated, a window 60 is displayed for work area 22 and a window 62 is displayed for work area 24. The window displays, in the illustrative example, the question “Swap Tool” to the user, and then includes the options “ACC” to accept or “DEC” to decline. Thus the users can choose to agree to accept or decline an invitation to exchange tools.

For the purposes of example, it is assumed that users 10, 6 respond affirmatively, and then as illustrated in FIG. 2(d) the work areas for each user are rotated so that each user now has a new work area. As illustrated in FIG. 2(d), user 6 now has work area 20, user 8 now has work area 22, and user 10 now has work area 24.

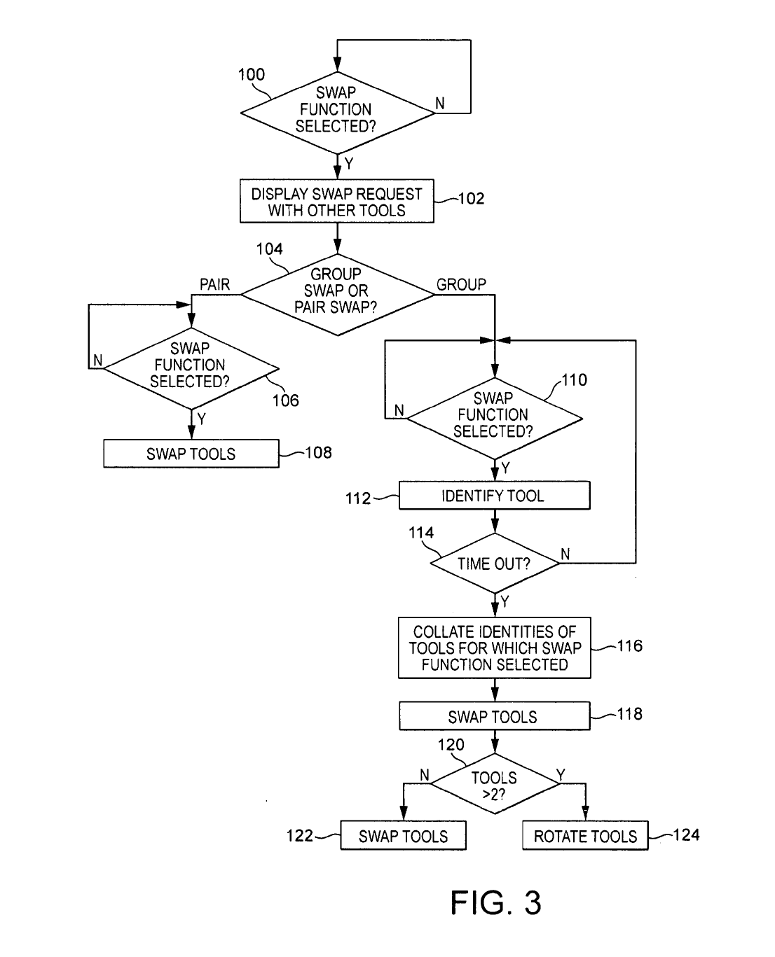

FIG. 3 illustrates an exemplary flow process for a method associated with the illustrative embodiment of FIGS. 2(a) to 2(d).

In response to a user selecting a swap function in step 100, a swap (or exchange) request is displayed to the other users in the collaborative exercise in step 102.

It is then determined in step 104 whether the swap is to be a group swap or a pair swap. In a pair swap a swap takes place with the first user to respond to the request, in a group swap a swap takes place amongst all users who respond.

In the event of a pair swap, in step 106 it is determined if a swap function has been selected by one other tool after the initial request. This is equivalent to one user accepting a swap request. If so a swap then takes place in step 108.

In the event of a group swap, in step 110 it is determined if a swap function has been selected by any other tool, and if so the identify of that tool is determined in step 112.

In an embodiment, as denoted by step 114 a certain amount of time is allowed for users to respond, and until that time expires the system monitors for other tools selecting a swap function in step 110.

In an alternative, as described with respect to FIGS. 2(a) to 2(d), rather than use an elapsed time system, the ‘Accept’ and ‘Decline’ options may be provided. In an extension of this embodiment, the exchange operation requires all users to agree to exchange, and in the event any one user declines the whole swap operation is cancelled: and for the exchange to happen all users have to accept.

Alternatively, the decline option could be used as a personal opt out for any user, e.g. in the example of FIGS. 2(a) to 2(d) one user can accept and one user can decline, in which case only 2 out of 3 users content is swapped.

Returning to the arrangement described in FIG. 3, after the time expires in step 114, the identities of all tools for which a swap function has been selected are collated in step 116.

The tools are then swapped in step 118.

If the number of tools being swapped is determined to be greater than two in step 120, then in one arrangement a determination is made as to how to swap the tools. In one arrangement, as denoted by step 124, the tools are swapped in rotation, for example with each tool moving one user position in a generally clockwise or counter-clockwise direction. Alternatively as denoted by step 122 the tools may be swapped in accordance with some other determined criteria, such as the order in which the swap acceptances were received.

In the process of FIG. 3 reference is made to the swapping of tools between users. This may be assumed to be a reference to swapping tools specifically, or swapping any window.

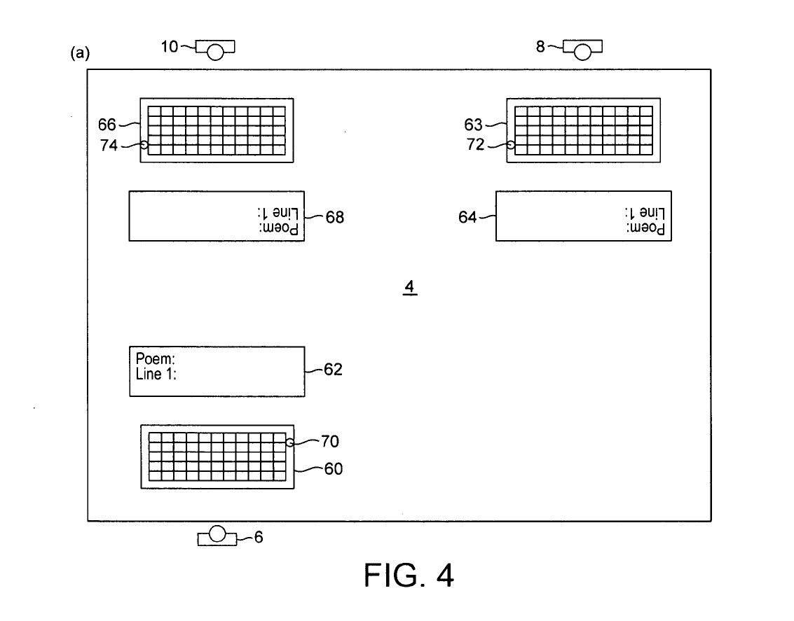

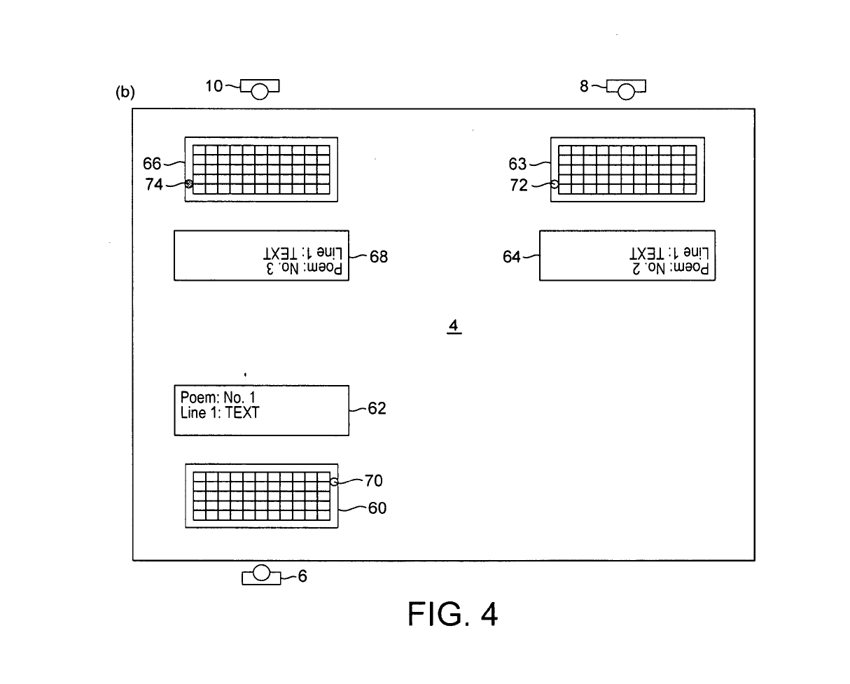

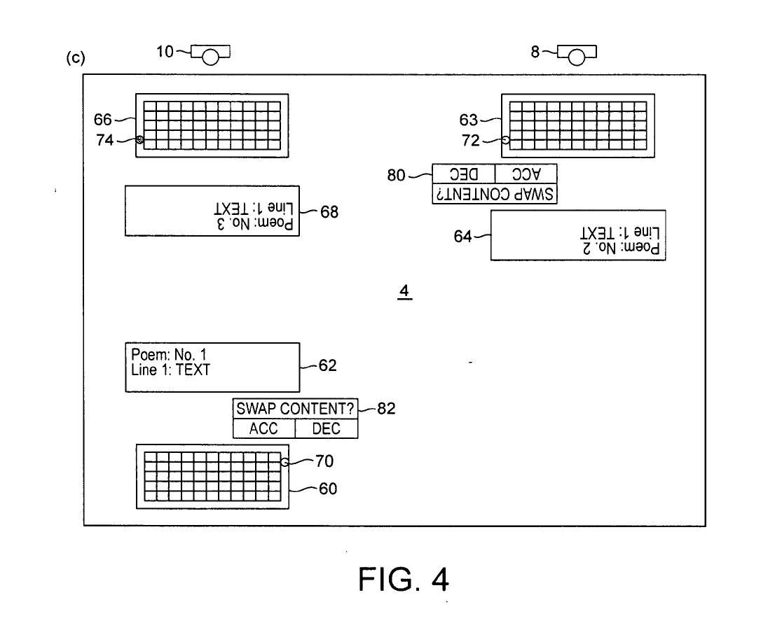

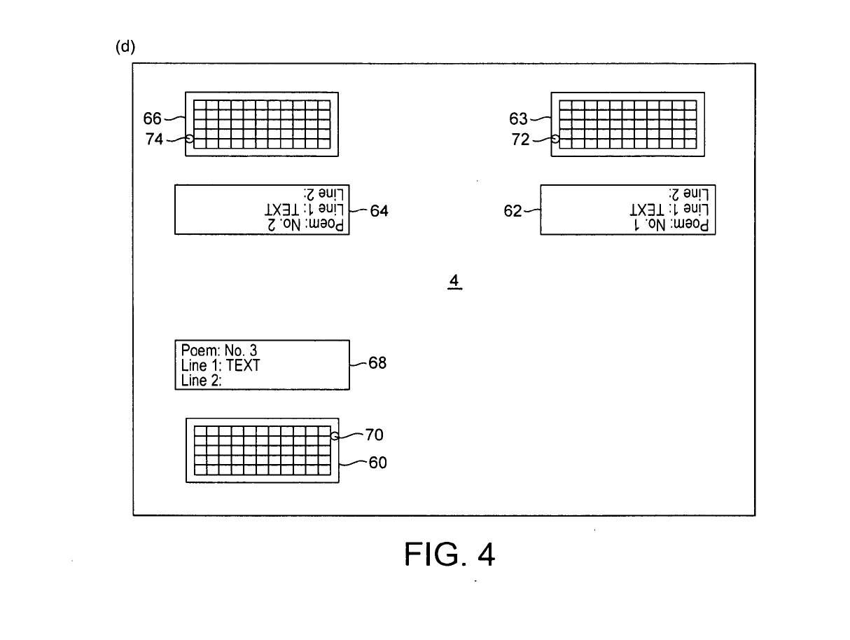

A second embodiment of the invention is illustrated with reference to FIGS. 4(a) to 4(d).

There is illustrated three work areas on an interactive display surface again associated with the three users 6, 8, 10. Each work area comprises multiple sub areas, including tools and content and user input areas. As illustrated, in this example each work area comprises a user input area, comprising a keyboard. Each work area additionally includes a content window, for displaying content entered by the user with their keyboard.

Thus user 6 is associated with a virtual keyboard 60 and a content display area 62; user 8 is associated with a virtual keyboard 63 and a content display area 64; and user 10 is associated with a virtual keyboard 66 and a content display area 68.

As illustrated in FIG. 4(a) each of the keyboards 60, 63, 66 is provided with an additional user interface icon 70, 72, 74 respectively. As in the arrangement of FIGS. 2(a) to 2(d), the additional user interface icons 70, 72, 74—which will be referred to hereafter as buttons are provided to enable collaborative sharing between the users. The buttons may be referred to as collaborative sharing buttons. The buttons are used by the users to initiate or request an exchange of tools and/or content and/or to accept a request for an exchange of tools and/or content.

In the example embodiment of FIG. 4(a) each user 6, 8, 10 uses their respective keyboard 60, 63, 66 to write a first line of a poem. The text entered on the respective keyboards 60, 63, 66 appears in the respective content windows 62, 64, 68.

As illustrated in FIG. 4(b), the button 74 associated with the keyboard 66 is shown shaded, indicating that it has been selected by the user 10. The user 10 has thus selected to make a request for content to be swapped between collaborative users 6, 8, 10.

As illustrated in FIG. 4(c), each of the other two users then has a window 80, 82 displayed adjacent their keyboard display areas 63, 60, responsive to the selection of the button in FIG. 4(b), requesting them to exchange content.

As illustrated, a window 80 is displayed for keyboard 63 and a window 82 is displayed for keyboard 60. The windows display, in the illustrative example, the question “Swap Content?” to the user, and then include the options “ACC” to accept or “DEC” to decline. Thus the users can choose to agree to accept or decline an invitation to exchange content.

In this example it is assumed that all users respond affirmatively, and then as illustrated in FIG. 4(d) the content display areas are rotated so that each user now has a new content area. The keyboards are unchanged.

Thus user 6 and keyboard 60 are now associated with content 68; user 8 and keyboard 63 are now associated with content 64; and user 10 and keyboard 66 are now associated with content 68.

Thus each user can now enter the second line to follow the first line written by someone else, such that each poem is constructed in a collaborative manner.

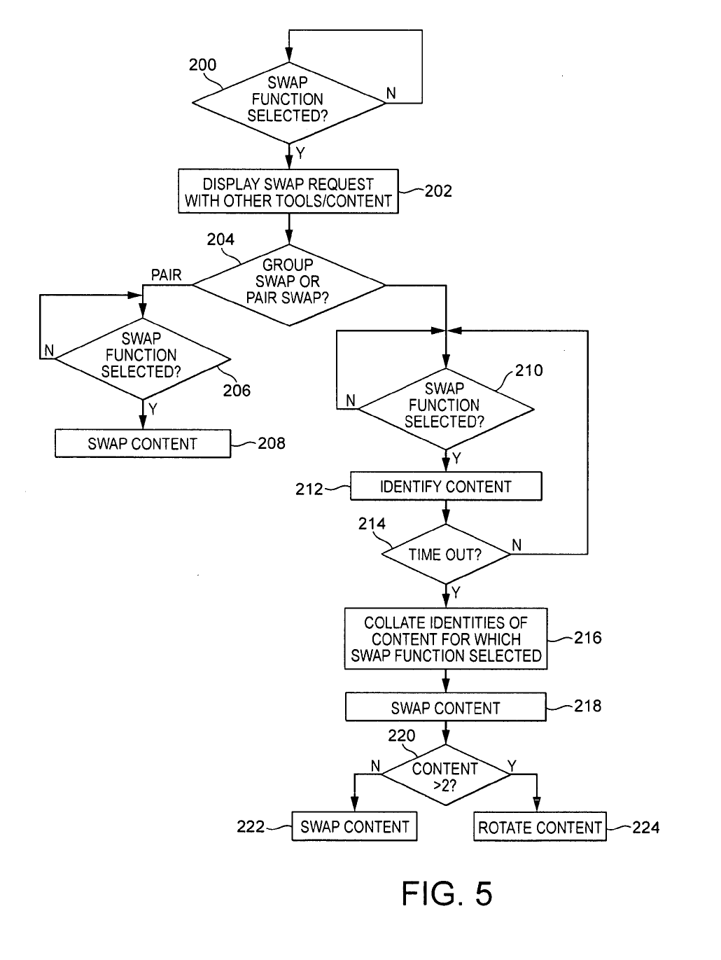

FIG. 5 illustrates an exemplary flow process for a method associated with the illustrative embodiment of FIGS. 4(a) to 4(d).

In response to a user selecting a swap function in step 200, a swap request is displayed to the other users involved in the collaborative exercise as denoted by step 202.

It is then determined in step 204 whether the swap is to be a group swap or a pair swap. In a pair swap a swap takes place with the first user to respond, in a group swap a swap takes place amongst all users who respond.

In a pair swap, as denoted by step 206, it is determined if a swap function has been selected by one other user, and if so a swap of content then takes place in step 208.

In a group swap, as denoted by step 210, it is determined if a swap function has been selected by any other user, and if so the identify of the associated content is determined in step 212.

In an embodiment, as denoted by step 214 a certain amount of time is allowed for users to respond, and until that time expires the system monitors for other tools selecting a swap function in step 210.

In an alternative, as described with respect to FIGS. 4(a) to 4(d), rather than use an elapsed time system, the ‘Accept’ and ‘Decline’ options may be provided. In an extension of this embodiment, the exchange operation requires all users to agree to exchange, and in the event any one user declines the whole swap operation is cancelled: and for the exchange to happen all users have to accept.

Alternatively, the decline option could be used as a personal opt out for any user, e.g. in the example of FIGS. 4(a) to 4(d) one user can accept and one user can decline, in which case only 2 out of 3 users content is swapped.

Returning to the arrangement described in FIG. 5, a certain amount of time is allowed for users to respond, and until that time expires the system monitors for other content selecting a swap function.

After the time expires, the identities of all content for which a swap function has been selected are collated in step 216.

The content is then swapped in step 218.

If the number of tools being swapped is determined to be greater than two in step 220, then in one arrangement a determination us made as to how to swap the tools. In one arrangement, as denoted by step 224, the tools are swapped in rotation, for example with each tool moving one user position in a generally clockwise or counter-clockwise direction. Alternatively as denoted by step 222 the tools may be swapped in accordance with some other determined criteria, such as the order in which the swap acceptances were received.

In the process of FIG. 5 reference is made to the swapping of content between users. It can be understood that in such an arrangement the content associated with that user is exchanged, but in general the tool—or application—associated with the editing of that content is not exchanged. The user therefore retains whatever ability to edit content that they have. For example, if one user has an ability to edit images, and another does not, by exchanging the content different tools can be used to edit the content

The embodiments described above set out scenarios where an exchange requires initiation by one user, following which other users must join or agree to the exchange. In alternative, simpler scenarios, there may be no requirement for other users to choose to join the exchange or accept/decline the exchange. In such scenarios, an exchange may occur without the need for any confirmation panels to be displayed on the user interface, such as the panels 60 and 62 of FIG. 2(c) and the panels 80 and 82 of FIG. 4(c). Two embodiments are now described which relate to such a scenario.

In a first embodiment, a user touches the content swap button which is displayed in accordance with any other embodiment described herein. Responsive to selection of the exchange function in this way, a swap happens instantly without any confirmation or input from any of the other users. The nature of the swap may be implementation dependent. For example the swap may take place between all active users. The swap may be initiated with an adjacent or opposite user. The swap may be initiated between one or more other users with which there is a predetermined association. The ability to effect an exchange in this way may be reserved for only certain users having a higher level of user authority than other users, such as a teacher user.

In a second embodiment, each user is required to touch their content swap button which is displayed for each user in accordance with any other embodiment described herein. The swap does not happen until all users who have access to a swap button have selected their swap button. In this embodiment each content swap button acts as flag that, when selected, indicates that the user is ‘ready to swap’. When all flags have been raised—i.e. all users have selected the exchange button—the swap operation is enabled. This embodiment thus requires each user to effectively agree to an exchange, but without a specific request to each user.

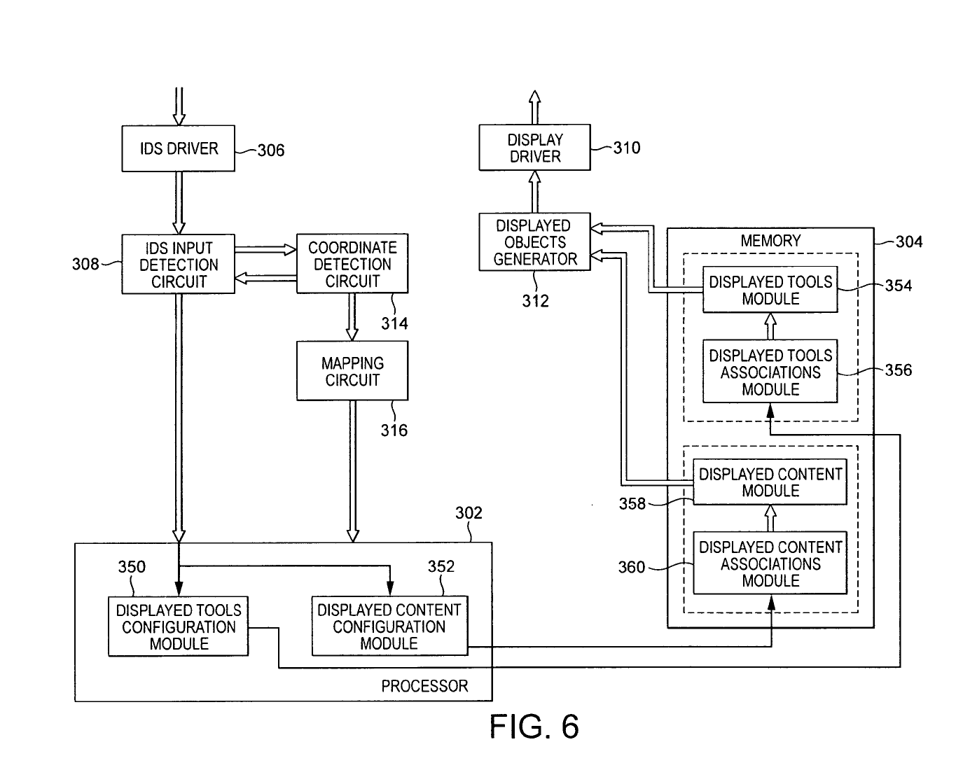

With reference to FIG. 6 there is illustrated the functional components of a computing system associated with an interactive display system required to support the functionality associated with the embodiments of the invention. Only those components that are relevant to understanding the invention and its embodiments are illustrated. One skilled in the art will appreciate that additional functional elements will be required to fully implement an appropriate computing system. The described functional components may be implemented in a variety of ways, for example on a computer system associated with the interactive display surface, such as a personal computer, laptop computer, or other portable of handheld computing device, or integrated with the interactive display surface itself.

The computing system includes a processor 302 including a displayed tools configuration module 350 and a displayed content configuration module 352; a memory 304 including a displayed tools module 354, a displayed tools associations module 356, a displayed content module 358, and a displayed content associations module 360; an interactive display surface driver 306; an interactive display surface detection circuit 308; a display driver 310; a displayed object generator 312; a coordinate detection circuit 314; and a mapping circuit 316.

The interactive display surface driver 306 receives data representing detected inputs (such as touch inputs) at the interactive display surface, and forwards such inputs to the interactive display surface detection circuit 308.

The interactive display surface input detection circuit 308 provides the received input data to the coordinate detection circuit 314 to determine coordinate information for each input, such as each touch input.

The coordinate detection circuit 314 provides coordinate information associated with each detected input to the interactive display surface detection circuit 308, and the mapping circuit 316.

The interactive display surface input detection circuit provides the detected input data together with coordinate information to the processor 302.

The memory 304 includes the displayed tools module 354 for storing data associated with tools displayed on the interactive display surface, and is utilized in accordance with the embodiment of the invention described with reference to FIG. 3. The data associated with tools displayed on the interactive display surface includes positional data for identifying the position in which the tool is to be displayed on the display. This may be defined by way of a relationship with a user, and/or by coordinate information.

The memory 304 also includes the displayed tools associations module 356 adapted to store the association of any displayed tools with a given user, in an embodiment. This information is provided to the module 354.

The displayed tools module 354 is connected to the displayed objects generator 312 to provide information on tools to be displayed. The displayed objects generator 312 is connected to the display driver 310, which generates display drive signals to the interactive display surface for displaying active objects.

The mapping circuit receives signals from the coordinate detection circuit 314 and the displayed objects module 320 to provide information to the processor 302 identifying when a received input coincides with a displayed object.

The displayed tool associations are set under the control of the displayed tools configuration module 350 of the processor 302. Responsive to the processor receiving an input signal from the interactive display surface detection circuit 308 that a received input is associated with acceptance to exchange tools, the input is directed by the processor to the displayed tools configuration module 350, and the displayed tools associations module 356 is updated under control of the module 350. The module 350 receives the exchange acceptance signals from all relevant tools, and then provides the updated association information of tools with users, in an embodiment, to module 356.

The memory 304 includes the displayed content module 358 for storing data associated with content displayed on the interactive display surface, and is utilized in accordance with the embodiment of the invention described with reference to FIG. 5. The data associated with content displayed on the interactive display surface includes positional data for identifying the position in which the content is to be displayed on the display. This may be defined by way of a relationship with a user or a tool associated with a user, and/or by coordinate information.

The memory 304 also includes the displayed content associations module 360 adapted to store the association of any displayed tools with a given user, in an embodiment. This information is provided to the module 358.

The displayed content module 358 is connected to the displayed objects generator 312 to provide information on content to be displayed. The displayed objects generator 312 is connected to the display driver 310, which generates display drive signals to the interactive display surface for displaying active objects.

The displayed content associations are set under the control of the displayed content configuration module 352 of the processor 302. Responsive to the processor receiving an input signal from the interactive display surface detection circuit 308 that a received input is associated with acceptance to exchange content, the input is directed by the processor to the displayed content configuration module 352, and the displayed content association module 360 is updated under control of the module 352. The module 352 receives the exchange acceptance signals from all relevant content (or via an associated tool or user), and then provides the updated association information of content with users or user tools), in an embodiment, to module 360.

One skilled in the art will appreciate that the arrangement of FIG. 9 is exemplary, and a computer system may be modified, controlled or adapted in various ways to support the functionality of the present invention.

All examples and embodiments described herein may be combined in various combinations, and are not mutually exclusive.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

1. A method for an interactive display surface adapted to detect multiple inputs, the method comprising: associating a plurality of displayed objects with a respective plurality of inputs; and selectively exchanging the objects between at least two inputs.

2. The method of claim 1 wherein the objects comprise user content.

3. The method of claim 1 wherein the plurality of displayed objects comprises one of: a plurality of displayed tools;
a plurality of displayed content of a document under the control of a tool;
a displayed tool and a displayed content associated with said tool.

4. (canceled)

5. (canceled)

6. The method of claim 1 wherein the plurality of inputs are associated with a respective plurality of users.

7. The method of claim 1 further comprising displaying a graphical user icon in association with at least one of said objects, wherein the step of selectively exchanging is initiated responsive to selection of said icon.

8. The method of claim 7 wherein responsive to selection of said icon, a further graphical user icon is displayed in association with at least one further object, wherein responsive to selection of said further icon the step of exchanging is enabled.

9. The method of claim 8 wherein the step of exchanging is enabled between the input associated with the icon and the input associated with the further icon which is first selected.

10. The method of claim 8 wherein the step of exchanging is enabled between the input associated with the icon and all inputs associated with further icons which are selected, and
wherein the exchange is based on an exchange between inputs in dependence on an order of inputs;
and wherein each object is exchanged with the input next adjacent in the order.

11. (canceled)

12. (canceled)

13. The method of claim 6 wherein the step of exchanging comprises one of: exchanging the content associated with objects;
exchanging the tool associated with objects;
exchanging the content and tool associated with objects.

14-20. (canceled)

21. A computer system for an interactive display surface adapted to detect multiple inputs, further adapted to: associate a plurality of displayed objects with a respective plurality of inputs; and selectively exchange the objects between at least two inputs.

22. The computer system for an interactive display surface of claim 21 wherein the objects comprise user content.

23. The computer system for an interactive display surface of claim 21 wherein the plurality of displayed objects comprise one of: a plurality of displayed tools;
a plurality of displayed content of a document under the control of a tool;
a displayed tool and a displayed content associated with said tool.

24. (canceled)

25. (canceled)

26. The computer system for an interactive display surface of claim 21 wherein the plurality of inputs are associated with a respective plurality of users.

27. The computer system for an interactive display surface of claim 21 further adapted to display a graphical user icon in association with at least one of said objects, wherein selectively exchanging is initiated responsive to selection of said icon.

28. The computer system for an interactive display surface of claim 27 wherein responsive to selection of said icon, a further graphical user icon is displayed in association with at least one further object, wherein responsive to selection of said further icon the step of exchanging is enabled.

29. The computer system for an interactive display surface of claim 28 wherein the exchanging is adapted to be enabled between the input associated with the icon and the input associated with the further icon which is first selected.

30. The computer system for an interactive display surface of claim 28 wherein the exchanging is adapted to be enabled between the input associated with the icon and all inputs associated with further icons which are selected;
wherein the exchange is based on an exchange between inputs in dependence on an order of inputs;
wherein each object is exchanged with the input next adjacent in the order.

31. (canceled)

32. (canceled)

33. The computer system for an interactive display surface of claim 26 wherein the step of exchanging comprises one of: exchanging the content associated with objects;
exchanging the tool associated with objects;
exchanging the content and tool associated with objects.

34-40. (canceled)

41. A computer program for performing the method of claim 1.

42. A computer program product for storing computer program code which, when run on a computer, performs the method of claim 1.
